(19) United States
(12) Patent Application Publication
(10) Pub. No.: US 2014/0222938 A1
(43) Pub. Date: Aug. 7, 2014

(54) METHOD AND SYSTEM FOR AUTOMATICALLY DELETING INSTANT MESSAGING INFORMATION

(71) Applicant: TENCENT TECHNOLOGY (SHENZHEN) COMPANY LIMITED, Guangdong (CN)

(72) Inventors: Xing LIANG, Guangdong (CN); Qing HUANG, Guangdong (CN); Bin ZHANG, Guangdong (CN)

(73) Assignee: TENCENT TECHNOLOGY (SHENZHEN) COMPANY LIMITED, Guangdong (CN)

(21) Appl. No.: 14/251,355

(22) Filed: Apr. 11, 2014

Related U.S. Application Data
(63) Continuation of application No. PCT/CN2012/081687, filed on Sep. 20, 2012.

(30) Foreign Application Priority Data
Nov. 18, 2011 (CN) 201110367413.X

(51) Int. Cl. H04L 12/58

(52) U.S. Cl. CPC H04L 51/18
USPC 709/206

(57) ABSTRACT

The present invention discloses a method for automatically deleting instant messaging information. The method includes receiving, by an information transmission terminal, an automatic deletion command from a user of a transmitter, carrying the command in information to be transmitted, transmitting the information; and receiving and playing or displaying, by an information receiving terminal, the information, determining whether the information carries the automatic deletion command, if the information carries the automatic deletion command, deleting the information automatically. In the present invention, the information is deleted automatically according to a command of the user of the information transmission terminal after the information receiving terminal receives and plays the information.

### FIELD OF THE INVENTION

The present invention relates to mobile communication, and particularly to a method and system for automatically deleting instant messaging (IM) information.

### BACKGROUND OF THE INVENTION

In current mobile communication technology, information is transmitted among mobile communication devices through IM tools in a manner such as texts, pictures, voices or videos and so on. And it gets the favor of users, since only little traffic is consumed. However, after a transmitter sends the information, he looses the control of the information, and cannot delete the information. If the information is needed to be deleted, the information has to be deleted manually by a receiver. Otherwise, the information is saved in the mobile communication device of the receiver. In view of the above, when important information exists, the information or privacy will be leaked easily, if the receiver forgets to delete the information in time.

### SUMMARY OF THE INVENTION

A method and system for automatically deleting IM information is provided in the present invention, so that an information receiving terminal can delete the information according to a command of a user of an information transmission terminal after the information receiving terminal receives and plays the information.

A technical solution in the present invention is implemented as follows:

A method for automatically deleting instant messaging information includes:

receiving, by an information transmission terminal, an automatic deletion command from a user of a transmitter;

carrying, by an information transmission terminal, the command in information to be transmitted;

transmitting, by an information transmission terminal, the information;

receiving by an information receiving terminal, the information;

playing or displaying, by the information receiving terminal, the information;

determining, by the information receiving terminal, whether the information carries the automatic deletion command, if the information carries the automatic deletion command, deleting the information automatically.

An instant communication system for automatically deleting instant messaging information includes:

an information transmission terminal, to receive an automatic deletion command from a user of the information transmission terminal, carry the command in information to be transmitted, and transmit the information;

an information receiving terminal, to receive the information, and play or display the information, determine whether the information carries the automatic deletion command, if the information carries the automatic deletion command, delete the information automatically.

It can be seen that in the method and system for automatically deleting IM information provided in the present invention, the automatic deletion command set by the user of the transmitter is added to the information, so that the information can be deleted automatically after arriving at the information receiving terminal.

### BRIEF DESCRIPTION OF DRAWINGS

In order to describe the technical solution clearly, drawings are briefly introduced as follows. Obviously, the drawings described as follows are for some examples of the present invention. Under the premise of not paying the creative work, persons having ordinary skill in the art can achieve other drawings.

FIG. 1 is a flowchart illustrating a method for transmitting information in accordance with an example of the present invention;

FIG. 2 is a flowchart illustrating a method for receiving and deleting information in accordance with an example of the present invention;

FIG. 3 is a schematic diagram illustrating a structure of an IM system for automatically deleting information in accordance with an example of the present invention.

### DETAILED DESCRIPTION OF THE INVENTION

In order to make the technical scheme and advantages of the present invention clearer, the present invention is described in further detail hereinafter with reference to accompanying drawings and examples.

A method for automatically deleting IM information is provided in an example of the present invention, which includes:

receiving, by an information transmission terminal, an automatic deletion command from a user of the information transmission terminal, carrying the command in information to be transmitted, transmitting the information;

receiving and playing or displaying, by an information receiving terminal, the information, determining whether the information carries the automatic deletion command, if carrying, deleting the information automatically.

In the method above, carrying, by the information transmission terminal, the command in information to be transmitted includes setting a value of a flag in the information.

Accordingly, determining, by the information receiving terminal, whether the information carries the automatic deletion command includes determining whether a value of the flag in the information is a preset value according to a communication protocol established between the information transmission terminal and the information receiving terminal, if yes, determining that the information carries the automatic deletion command.

In addition, after the information receiving terminal determines that the automatic deletion command is carried in the information, and before the information is deleted, the method may further includes: notifying a user of the information receiving terminal to choose whether he agrees to delete the information. Afterwards, the information receiving terminal deletes the information after a deletion agreement command is received from the user of the information receiving terminal.

The information receiving terminal can delete the information in several ways, such as deleting the information immediately after the information is played or displayed; or, deleting the information after a preset time interval after the information is played or displayed.

The information above may be information in various forms, such as voice information, text information, video information, image information and so on. The information transmission terminal and the information receiving terminal above may be a smart phone, a flat computer, a notebook computer etc. The information is transferred between the information transmission terminal and the information receiving terminal in accordance with the communication protocol configured by an IM tool. And the form of the information, the information transmission terminal and the information receiving terminal are not limited in the present invention.

An example is described as follows for detail introduction.

The procedure of the example is divided into two stages for the introduction. A first stage is a process that an information transmission terminal transmits information. A second stage is a process that an information receiving terminal receives the information and deletes the information automatically.

The first stage:

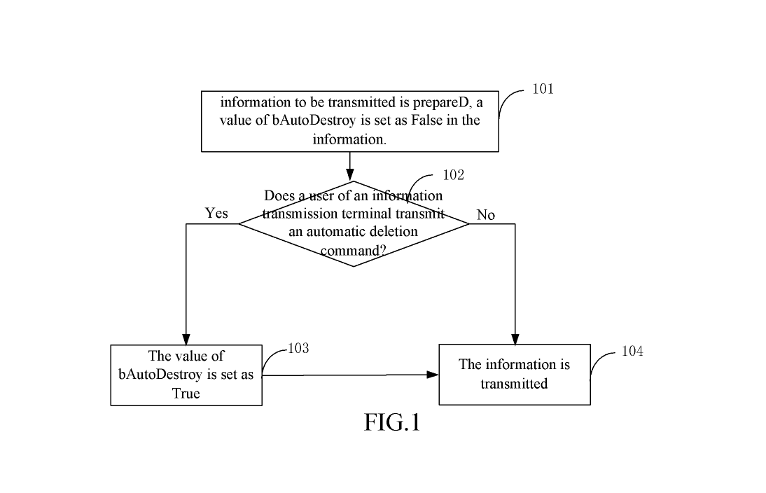

FIG. 1 is a flowchart illustrating a method for transmitting information. The method includes:

In step 101, the information transmission terminal prepares information to be transmitted. A value of flag bAutoDestroy is set in the information, where the value of bAutoDestroy is set as False.

In step 102, it is determined whether a user of the information transmission terminal transmits an automatic deletion command. If the command has already been transmitted, proceeds to step 103. Otherwise, the value of bAutoDestroy is still set as False, and then proceeds to step 104.

In step 103, the value of bAutoDestroy is set as True.

In step 104, the information is transmitted.

The second stage:

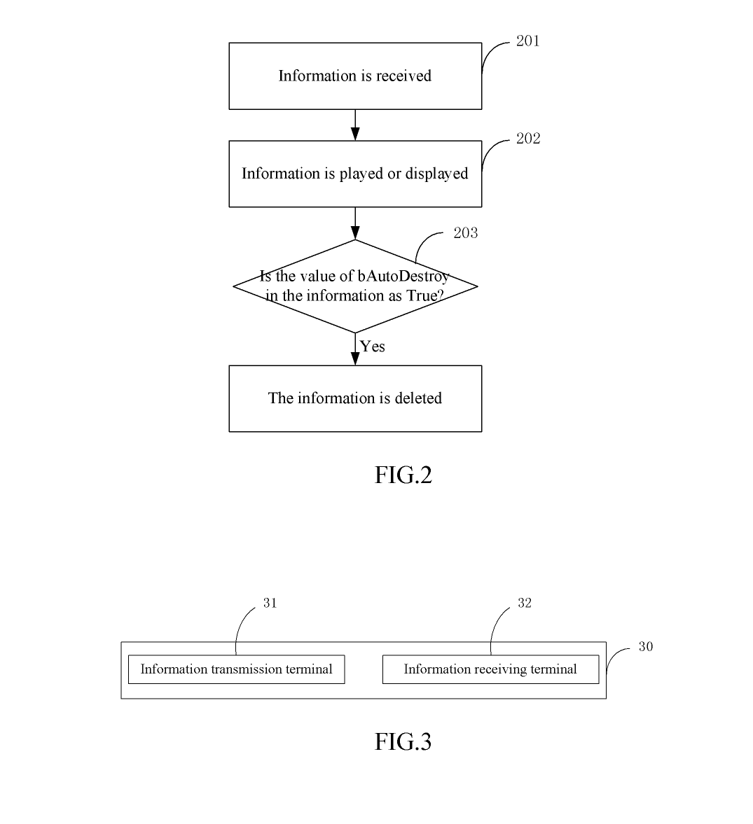

FIG. 2 is a flowchart illustrating a method for automatically receiving information and deleting information in accordance with an example of the present invention. The method includes:

In step 201, the information receiving terminal receives information.

In step 202, the information receiving terminal plays or displays the information.

In step 203, it is determined whether the value of the flag bAutoDestroy is True. If the value of bAutoDestroy is True, the information is deleted immediately after the information is played or displayed, or the information is deleted after a preset time interval after the information is played or displayed. If bAutoDestroy is False, the process ends.

In another example of the present invention, after the information receiving terminal determines that the value of bAutoDestroy is True, a user of the information receiving terminal is notified to choose whether he agrees to delete the information (there are various ways of notification, such as image, voice etc.). After a deletion agreement command from the user of the information receiving terminal is received, the information is deleted. If the deletion agreement command from the user of the information receiving terminal is not received, the information may be saved temporarily.

As shown in FIG. 3, a communication system 30 for automatically deleting information is provided in the present invention, which includes:

an information transmission terminal 31, to receive an automatic deletion command from a user of the information transmission terminal 31, carry the command in information to be transmitted, and transmit the information;

an information receiving terminal 32, to receive the information, play or display the information, determine whether the information carries the automatic deletion command, if the information carries the automatic deletion command, delete the information automatically.

When the information transmission terminal 31 carries the command in the information to be transmitted, the information transmission terminal 31 is to set a value of a flag in the information.

Accordingly, the information receiving terminal 32 determines whether the information carries the automatic deletion command by determining whether the value of the flag in the information is a preset value according to a communication protocol established between the information transmission terminal 31 and the information receiving terminal 32. And if the value of the flag in the information is a preset value, it is determined that the information carries the automatic deletion command.

The information receiving terminal 32 above is further to notify the user of information receiving terminal 32 to choose whether he agrees to delete the information after determining that the information carries the automatic deletion command, delete the information after a deletion agreement command from the user of the information receiving terminal 32 is received.

In the system above, when the information receiving terminal 32 deletes the information automatically, the information receiving terminal 32 is to delete the information immediately after the information is played or displayed, or delete the information after a preset time interval after the information is played or displayed.

The information above may be one of text information, voice information, video information and image information.

It can be seen from the above that a method and system for automatically deleting instant messaging information is provided in the present invention. The information can be deleted automatically after the information arrives at an information receiving terminal by adding an automatic deletion command configured by a user of an information transmission terminal to the information. Furthermore, before the information is deleted, agreement of a user of the information receiving terminal may be obtained firstly.

The foregoing is only preferred examples of the present invention, and the protection scope of the present invention is not limited to these examples. Any improvement and replacement which can be made in the technical scope disclosed by the present invention by those skilled in the art should be covered in the protection scope of the invention. And thus, the protection scope of the present invention should be defined by the claims.

### INDUSTRIAL APPLICABILITY

A method and system for automatically deleting instant messaging information is provided in the present invention. The information can be deleted automatically after the information arrives at an information receiving terminal by adding an automatic deletion command configured by a user of an information transmission terminal to the information. Furthermore, before the information is deleted, agreement of a user of the information receiving terminal may be obtained firstly.

1. A method for automatically deleting instant messaging information, comprising:
receiving, by an information transmission terminal, an automatic deletion command from a user of a transmitter;
carrying, by the information transmission terminal, the command in information to be transmitted;
transmitting, by the information transmission terminal, the information; and
receiving, by an information receiving terminal, the information;
playing or displaying, by the information receiving terminal, the information;
determining, by the information receiving terminal, whether the information carries the automatic deletion command, if the information carries the automatic deletion command, deleting the information automatically.

2. The method according to claim 1, wherein carrying, by the information transmission terminal, the automatic deletion command in information to be transmitted comprises: setting a value of a flag in the information;
determining, by the information receiving terminal, whether the information carries the automatic deletion command comprises: determining whether the value of the flag in the information is a preset value according to a communication protocol established between the information transmission terminal and the information receiving terminal, if yes, determining that the information carries the automatic deletion command.

3. The method according to claim 1, further comprising:
after the information transmission terminal determines the information carries the automatic deletion command, and before the information is deleted, notifying a user of the information receiving terminal to choose whether he agrees to delete the information.

4. The method according to claim 3, wherein deleting the information automatically comprises:
deleting the information after an deletion agreement command is received from the user of the information transmission terminal.

5. The method according to claim 1, wherein deleting the information automatically comprises:
deleting the information immediately after the information is played or displayed; or
deleting the information after a preset time interval after the information is played or displayed.

6. The method according to claim 1, wherein the information is one of text information, voice information, video information and image information.

7. A method for receiving information and automatically deleting information, comprising:
receiving, by an information receiving terminal, information;
playing or displaying, by the information receiving terminal, the information;
determining, by the information receiving terminal, whether the information carries the automatic deletion command from a user of an information transmission terminal, if the information carries the automatic deletion command, deleting the information automatically.

8. The method according to claim 7, wherein determining, by the information receiving terminal, whether the information carries the automatic deletion command comprises: determining whether a value of a flag in the information is a preset value according to a communication protocol established between the information transmission terminal and the information receiving terminal, if yes, determining that the information carries the automatic deletion command, the value of the flag being set by the information transmission terminal.

9. The method according to claim 7, further comprising:
after the information transmission terminal determines the information carries the automatic deletion command, and before the information is deleted, notifying a user of the information receiving terminal to choose whether he agrees to delete the information;

10. The method according to claim 9, wherein deleting the information automatically comprises:
deleting the information after an deletion agreement command is received from the user of the information transmission terminal.

11. The method according to claim 7, wherein deleting the information automatically comprises:
deleting the information immediately after the information is played or displayed; or
deleting the information after a preset time interval after the information is played or displayed.

12. An instant communication system for automatically deleting instant messaging information, comprising:
an information transmission terminal, to receive an automatic deletion command from a user of the information transmission terminal, carry the command in information to be transmitted, and transmit the information;
an information receiving terminal, to receive the information, play or display the information, determine whether the information carries the automatic deletion command, if the information carries the automatic deletion command, delete the information automatically.

13. The system according to claim 12, wherein the information transmission terminal sets a value of a flag in the information;
the information receiving terminal determines whether the value of the flag in the information is a preset value according to a communication protocol established between the information transmission terminal and the information receiving terminal, if yes, determines that the information carries the automatic deletion command.

14. The system according to claim 12, wherein the information receiving terminal is further to notify a user of the information receiving terminal to choose whether he agrees to delete the information after the information receiving terminal determines the information carries the automatic deletion command, and delete the information after a deletion agreement command is received from the user of the information receiving terminal.

15. The system according to claim 12, wherein the information receiving terminal deletes the information immediately after the information is played or displayed; or deletes the information after a preset time interval after the information is played or displayed.

16. The system according to claim 12, wherein the information is one of text information, voice information, video information and image information.

17. An information receiving terminal, configured to implement a method comprising:
receiving, by an information receiving terminal, information;
playing or displaying, by the information receiving terminal, the information;
determining, by the information receiving terminal, whether the information carries the automatic deletion command from a user of an information transmission terminal, if the information carries the automatic deletion command, deleting the information automatically.

18. The information receiving terminal according to claim 17, configured to implement a method comprising:
determining whether a value of a flag in the information is a preset value according to a communication protocol established between the information transmission terminal and the information receiving terminal, if yes, determining that the information carries the automatic deletion command, the value of the flag being set by the information transmission terminal.

19. The information receiving terminal according to claim 17, configured to implement a method further comprising:
after the information transmission terminal determines the information carries the automatic deletion command, and before the information is deleted, notifying a user of the information receiving terminal to choose whether he agrees to delete the information, deleting the information after an deletion agreement command is received from the user of the information transmission terminal.

20. The information receiving terminal according to claim 17, configured to implement a method further comprising:
deleting the information immediately after the information is played or displayed; or
deleting the information after a preset time interval after the information is played or displayed.
